(19) United States
(12) Patent Application Publication
(10) Pub. No.: US 2006/0212940 A1
(43) Pub. Date: Sep. 21, 2006

(54) System and method for removing multiple related running processes

(76) Inventor: Michael Christopher Wilson, Westminster, CO (US)

Correspondence Address: COOLEY GODWARD LLP;ATTN: PATENT GROUP, THE BOWEN BUILDING, 875 15TH STREET, N.W. SUITE 800, WASHINGTON, DC, 20005-2221, US

(21) Appl. No.: 11/086,873

(22) Filed: Mar. 21, 2005

(51) Int. Cl. G06F 12/14

(52) U.S. Cl. 726/22

(57) ABSTRACT

Methods for managing multiple related pestware processes on a protected computer are described. One embodiment is configured to detect a pestware process and to identify related pestware watcher processes on the protected computer. This embodiment then suspends the pestware and related watcher processes so as to generate suspended processes. The suspended processes are then terminated so as to remove the pestware and related pestware watcher processes from program memory of the protected computer. In variations, a debug mode of an operating system of the protected computer is utilized to suspend and terminate the pestware process the related pestware watcher processes.

### RELATED APPLICATIONS

The present application is related to commonly owned and assigned Ser. No. 10/956,578, Attorney Docket No. WEBR-002/00US, entitled System and Method for Monitoring Network Communications for Pestware, which is incorporated herein by reference.

The present application is related to commonly owned and assigned Ser. No. 10/956,573, Attorney Docket No. WEBR-003/00US, entitled System and Method For Heuristic Analysis to Identify Pestware, which is incorporated herein by reference.

The present application is related to commonly owned and assigned Ser. No. 10/956,574, Attorney Docket No. WEBR-005/00US, entitled System and Method for Pestware Detection and Removal, which is incorporated herein by reference.

### COPYRIGHT

A portion of the disclosure of this patent document contains material that is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates to computer system management. In particular, but not by way of limitation, the present invention relates to systems and methods for controlling pestware or malware.

### BACKGROUND OF THE INVENTION

Personal computers and business computers are continually attacked by trojans, spyware, and adware, collectively referred to as “malware” or “pestware.” These types of programs generally act to gather information about a person or organization—often without the person or organization's knowledge. Some pestware is highly malicious. Other pestware is non-malicious but may cause issues with privacy or system performance. And yet other pestware is actual beneficial or wanted by the user. Wanted pestware is sometimes not characterized as “pestware” or “spyware.” But, unless specified otherwise, “pestware” as used herein refers to any program that collects and/or reports information about a person or an organization and any “watcher processes” related to the pestware.

Software is available to detect pestware, but pestware is difficult to remove while it is running, and as a consequence, pestware is typically terminated before attempts to remove the pestware are made. Generally, operating systems can terminate pestware, but a problem arises when the pestware is associated with a simultaneously running sympathetic process that can restart the pestware. For example, a watcher process can monitor a pestware program, and when the watcher process detects that the pestware program has been terminated, the watcher process could restart it, possibly under a new name. Similarly, when the watcher process is terminated, the pestware program could restart the watcher process. These types of mutually-sympathetic programs are difficult for traditional pestware-removal programs to handle. Accordingly, current software is not always able to remove these types of pestware and will most certainly not be satisfactory in the future.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

Embodiments of the present invention include methods for managing multiple related pestware processes on a protected computer. One embodiment is configured to detect a pestware process and then to identify related pestware watcher processes on the same protected computer. This embodiment then suspends both the pestware and related watcher processes so as to generate suspended processes. The suspended processes are then terminated so as to remove the pestware and related pestware watcher processes from program memory of the protected computer. In variations, a debug mode of an operating system of the protected computer is utilized to suspend and terminate the pestware process and the related pestware watcher processes. These and other embodiments are described in more detail herein.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 illustrates a block diagram of one implementation of the present invention;

FIG. 2 is a flowchart of one method for removing multiple related running processes; and

FIG. 3 is a flowchart of another method for removing multiple related running processes.

### DETAILED DESCRIPTION

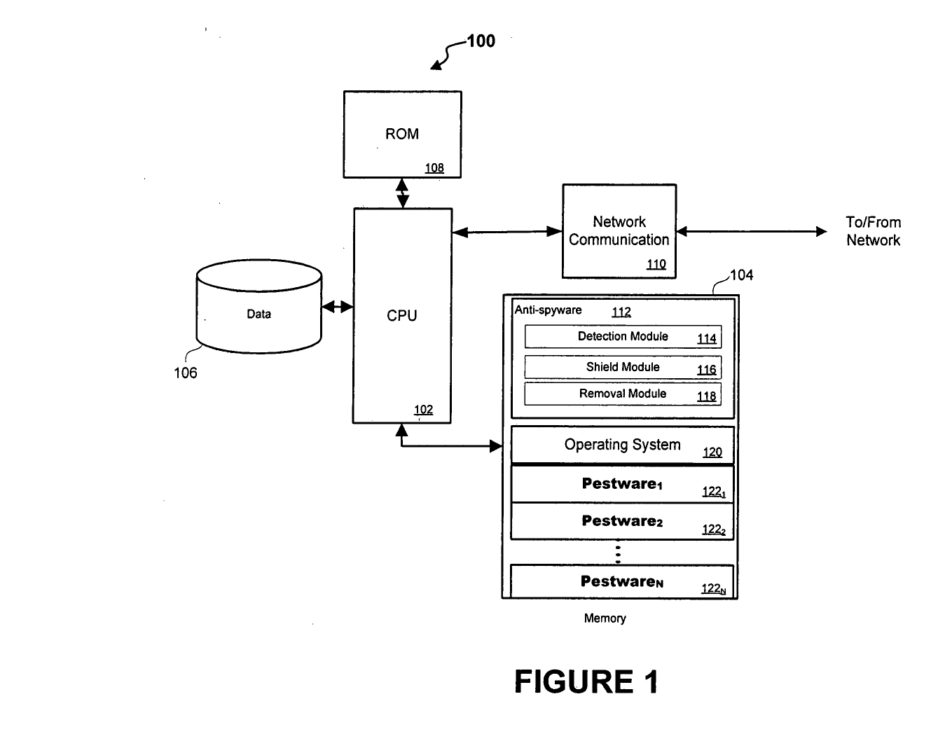

Referring now to the drawings, where like or similar elements are designated with identical reference numerals throughout the several views, and referring in particular to FIG. 1, it illustrates a block diagram 100 of a protected computer/system in accordance with one implementation of the present invention. The term “protected computer” is used to refer to any type of computer system, including personal computers, handheld computers, servers, firewalls, etc. This implementation includes a CPU 102 coupled to memory 104 (e.g., random access memory (RAM)), a storage device 106 (e.g., a hard drive), ROM 108 and network communication 110.

As shown, an anti-spyware application 112 includes a detection module 114, a shield module 116 and a removal module 118, which are implemented in software and are executed from the memory 104 by the CPU 102. In addition, an operating system 120 and N related, pestware processes 122_{1-N} are also depicted as running from memory 104. In the present embodiment, one or more of the N related, pestware processes 122_{1-N} are configured so as to restart any other ones of the N related, pestware processes 122_{1-N} when attempts are made to terminate them. For example, if two pestware, watcher processes are running, a first pestware process will restart the second pestware process if it is terminated, and similarly the second pestware process will restart the first pestware process if it is terminated.

The software 112, 120 can be configured to operate on personal computers (e.g., handheld, notebook or desktop), servers or any device capable of processing instructions embodied in executable code. Moreover, one of ordinary skill in the art will recognize that alternative embodiments, which implement one or more components (e.g., the anti-spyware 112) in hardware, are well within the scope of the present invention.

In the present embodiment, the operating system 120 is not limited to any particular type of operating system and may be operating systems provided by Microsoft Corp. under the trade name WINDOWS (e.g., WINDOWS 2000, WINDOWS XP, and WINDOWS NT). Additionally, the operating system may be an open source operating system such operating systems distributed under the LINUX trade name. For convenience, however, embodiments of the present invention are generally described herein with relation to WINDOWS-based systems. Those of skill in the art can easily adapt these implementations for other types of operating systems or computer systems.

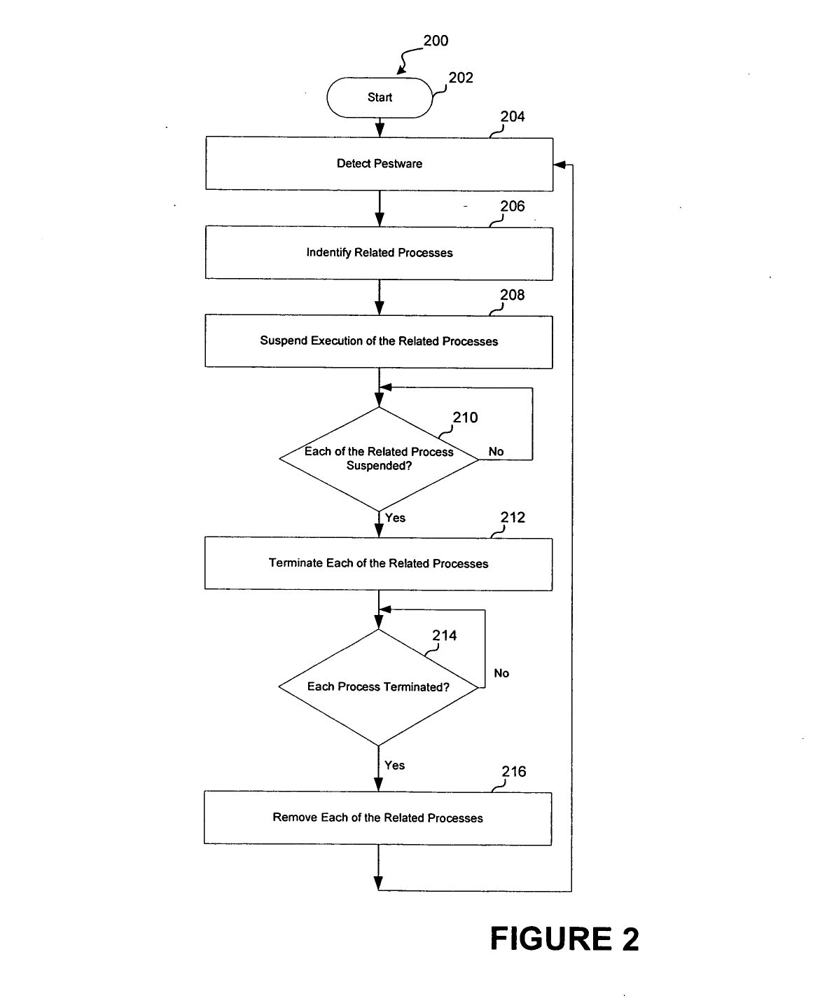

While referring to FIG. 1, simultaneous reference will be made to FIG. 2, which is a flowchart depicting steps traversed in accordance with a method to remove the multiple, related processes running from the memory 104 and storage 106. Initially, the presence of pestware 122 is detected by the detection module 114 and/or the shield module 116 (Blocks 202, 204).

Referring first to the detection module 114, it is responsible for detecting pestware or pestware activity on the protected computer or system. Typically, the detection module 114 uses pestware definitions to scan the files that are stored on a computer system or that are running on a computer system. In one embodiment for example, the definition includes a representation of a pestware file (e.g., a cyclical redundancy code (CRC) of a portion of the pestware file). In such an embodiment, the protected computer then calculates a CRC for each scanned file on the protected computer and compares it to the pestware definitions to determine whether a scanned file is pestware.

The definitions can also include information about suspicious activity for which the protected computer should monitor. The detection module 114 can also check WINDOWS registry files and similar locations for suspicious entries or activities commonly associated with pestware. Further, the detection module 114 can check the hard drive for third-party cookies.

Note that the terms “registry” and “registry file” relate to any file for keeping such information as what hardware is attached, what system options have been selected, how computer memory is set up, and what application programs are to be present when the operating system is started. As used herein, these terms are not limited to WINDOWS and can be used on any operating system.

Pestware and pestware activity can also be detected by the shield module 116, which generally runs in the background on the computer system. Shields can generally be divided into two categories: those that use definitions to identify known pestware and those that look for behavior common to pestware. This combination of shield types acts to prevent known pestware and unknown pestware from running or being installed on a protected computer.

In many cases, the detection and shield modules (114 and 116) detect pestware by matching files on the protected computer with definitions of pestware, which are collected from a variety of sources. For example, a host computers, protected computers and other systems can crawl the Web to actively identify pestware. These systems often download programs and search for exploits. The operation of these exploits can then be monitored and used to create pestware definitions. Various techniques for detecting pestware are disclosed in the above-identified and related application entitled: System and Method for Monitoring Network Communications for Pestware.

Notably, not all pestware is unwanted or undesirable, and automatic removal is not always an acceptable option for users of these programs. For example, popular file-sharing programs like KAZAA act as wanted spyware. Similarly, the popular GOOGLE toolbar acts as wanted spyware in certain instances. Because users typically want to retain these types of programs, embodiments of the present invention enable the user to selectively identify and retain pestware files. And in certain embodiments, the protected computer can retain a list of approved pestware so that in future sweeps, the computer does not quarantine any pestware included in the list.

If the pestware is undesirable, and the pestware program can be safely shut down while it is running, in one embodiment, the user is given the option of terminating the program. And if the user elects to terminate the program, the pestware is requested to shut itself down, through, for example a WM_CLOSE message. This request is typically issued through a WINDOWS call. If the pestware program does not terminate itself, then the WINDOWS application program interface (API) is requested to terminate the program. Broadly, if the program will not shut itself down, then the operating system is requested to shut the program down.

Typically, the operating system 120 can terminate any one of the processes 122_{1-N}. But one or more of any of the other pestware processes 122_{1-N} can restart the terminated process. These types of mutually-sympathetic programs are difficult for traditional pestware-removal programs to handle.

As a consequence, in the present embodiment, any pestware process that is related to the pestware process identified at Block 204 is also identified (Block 206). In one embodiment, pestware definitions are utilized to identify processes that are part of the same spy. For example, if multiple files are part of the same spy definition then they could potentially be watcher processes, and the termination methods described herein are implemented accordingly.

In addition, shielding technology may be utilized to identify a process that is restarting a given pestware process. In this way, a related process is identified if the definitions happen to miss the related process. For example, if there are two spy processes running (e.g., process A and process B), but the definitions only identified process A during a scan, then process B will restart process A after process A is terminated.

To address this situation, a shield (e.g., a Spy Installation Shield) is instructed to watch for process A to be restarted. If the shield sees process A get restarted, it identifies process B as the process that is restarting it. Both process A and B are then suspended and removed as described further herein. This technique is repeated if yet another process (e.g., process C) restarts processes A and B. Specifically, process C is identified as a related process and all the processes A, B and C are terminated.

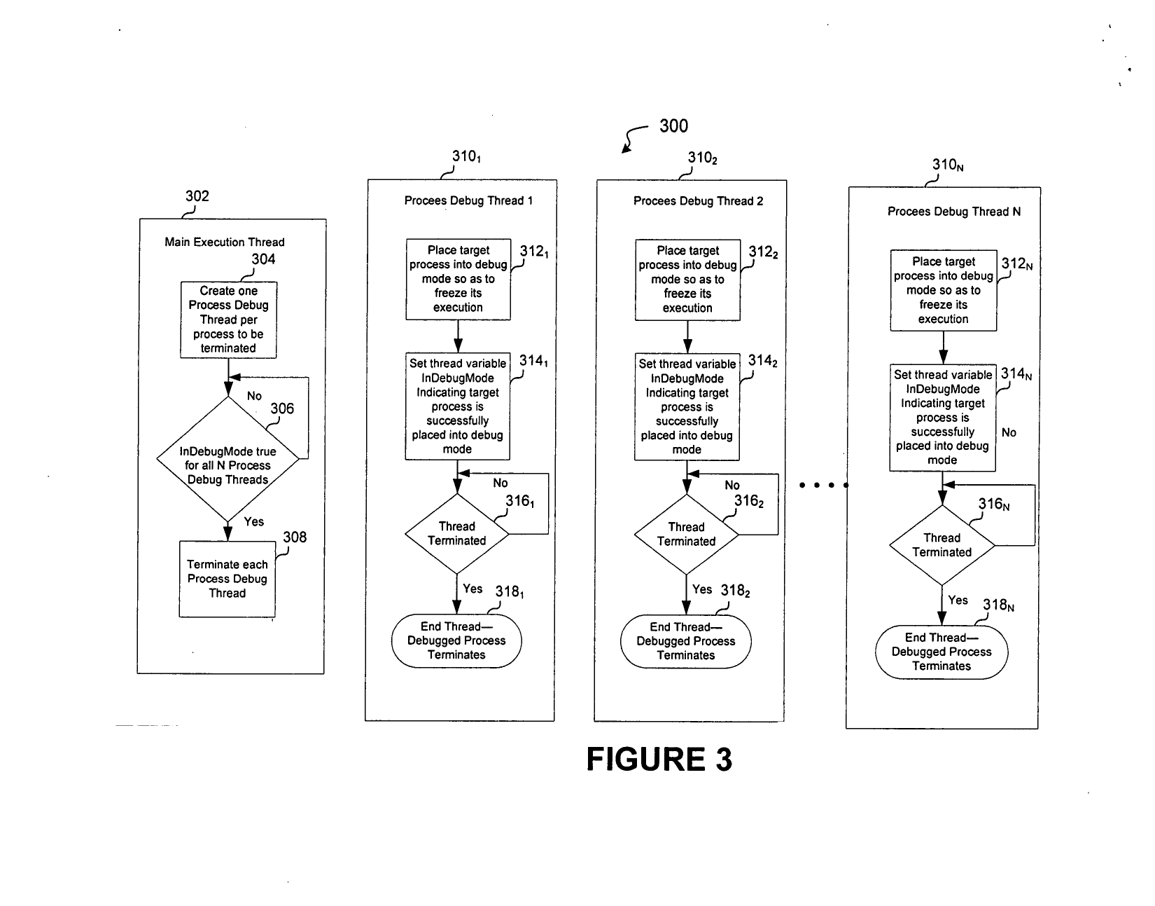

In some embodiments, any pestware process that is related to the pestware process is identified—regardless of whether it is a watcher process. In these embodiments, the related process(es) are simply terminated, in accordance with one or more of the techniques described herein with reference to FIGS. 2 and 3, without establishing whether the related process(es) include a watcher process. In other embodiments, however, a determination as to whether the related process(es) include a watcher process is made before terminating the related process(es).

In accordance with one implementation of the present invention, these related processes are addressed by suspending execution of each of the related processes 122_{1-N} (Block 208). Once suspended, each of the suspended processes is unable to watch the other processes, and hence, unable to restart an associated process that is terminated.

In one embodiment, suspension of each thread is achieved by enumerating all the threads in a process and then suspending each enumerated thread with a suspend thread API call. In another embodiment described further with reference to FIG. 3, by using the operating system's 120 debug API, each running process is suspended by placing the process in debug mode so that a debug thread is created for each of the associated processes. As one of ordinary skill in the art will appreciate, if the suspend thread API call is used, it is possible to fully restore the suspended process if it is desirable to do so (e.g., if the suspended process is not a spy process). If the debug API is utilized, it is possible to restore a suspended process to a running state, but typically, once debug mode has been initiated, shutting down the anti-spyware application 112 shuts down the suspended processes as well. It should be recognized that these techniques are merely exemplary and that other techniques to suspend the processes may be used as well.

Once each of the process threads 122_{1-N} is suspended (Block 210) so as to be unable to watch the other processes, then the processes 122_{1-N} are terminated (Block 212). In one embodiment, if each process was suspended using the suspend thread API call, then each the processes 122_{1-N} is then terminated by requesting the operating system 120 API to terminate each process. Alternatively, if each process was suspended by a process debug, termination of the process debug automatically terminates each of the processes 122_{1-N} so the processes 122_{1-N} are no longer resident in the memory 104. Once the processes 122_{1-N} are terminated (Block 214), the related process can be quarantined and deleted from storage 106 in the normal fashion (Block 216).

Referring next to FIG. 3, shown is a process flow diagram 300 depicting one method of carrying out Blocks 208-212 of FIG. 2 so as to remove the related processes 122_{1-N} from the protected computer. As shown, after detection and identification of the related pestware processes 122_{1-N}, a main execution thread 302 is initiated.

In this embodiment, the main execution thread 302 first creates one process debug thread for each of the N related processes 122_{1-N} so as to generate N process debug threads 310_{1-N} (Block 304). As shown, each of the N process debug threads 310_{1-N} places a corresponding one of the N related processes 122_{1-N} into debug mode so as to generate N suspended, related processes (Block 312). One of ordinary skill in art will recognize that the call to place each of the related processes 122_{1-N} into debug mode may vary from operating system to operating system. For example, a WINDOWS debug API call is utilized in embodiments where the operating system 120 is a WINDOWS operating system.

As shown, each of the N process debug threads 310_{1-N} then sets a corresponding thread variable (identified as InDebugMode) to true, so as to inform the main execution thread 302 that it has been successfully placed into debug mode (Block 314).

Once the main execution thread is informed that each of the N related processes 122_{1-N} has been placed into debug mode (Block 306), and hence, each of the N related processes 122_{1-N} has been suspended, then the main execution thread 302 terminates each of the N process debug threads 310_{1-N} (Block 308). As shown, when each of the N process debug threads 310_{1-N} is terminated (Block 316), then each of the N suspended related processes is also terminated (Block 318). In some embodiments, e.g., where the operating system 120 is a WINDOWS operating system (e.g., WINDOWS 95, 98, NT, XP), terminating the debug threads 310_{1-N} automatically terminates the N process debug threads 310_{1-N}.

In conclusion, the present invention provides, among other things, a system and method for managing pestware. Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for removing pestware comprising:
detecting a presence of a pestware process on a protected computer;
identifying at least one related process, wherein the at least one related process runs on the protected computer when the pestware process runs on the protected computer;
suspending the pestware process and the at least one related process, so as to generate at least two simultaneously suspended processes; and
terminating the at least two simultaneously suspended processes.

2. The method of claim 1 wherein the at least one related process is capable of restarting the pestware process in the event the pestware process is terminated

3. The method of claim 1, wherein the suspending includes requesting an operating system of the protected computer to suspend the pestware process with a first suspend request and requesting the operating system to suspend the at least one related process with at least one other corresponding suspend request, and wherein the terminating includes requesting the operating system to terminate each of the at least two suspended processes with a corresponding one of at least two termination requests.

4. The method of claim 1, wherein the suspending includes suspending the pestware process and the at least one related process by placing the pestware process and the at least one related process in debug mode so as to generate at least two process debug threads, each of the at least two process debug threads corresponding to one of the at least two suspended processes, and wherein the terminating includes terminating the at least two process debug threads.

5. The method of claim 1 wherein the related process collects information about activities on the protected computer.

6. The method of claim 1 wherein either the pestware process or the related process is suspended before the other.

7. The method of claim 1 wherein one of the at least two simultaneously suspended processes is terminated before another of the of the at least two simultaneously suspended processes.

8. The method of claim 1, wherein the suspending the pestware process and the at least one related process includes preventing the pestware process and the at least one related process from being accessed by a processor of the protected computer.

9. The method of claim 1 wherein the identifying includes establishing that the pestware process has been previously terminated so as to indicate that a process running simultaneously with the pestware process is the related process.

10. A system for managing pestware comprising:
a pestware detection module configured to detect a pestware process and a related process on a protected computer, the protected computer including a storage device and a program memory, wherein the related process runs simultaneously with the pestware process; and
a pestware removal module configured to:
suspend both the pestware process and the related process so as to generate a first suspended process and a second suspended process, the first and second suspended processes being suspended contemporaneously; and
terminate the first suspended process and a second suspended process so as to remove the pestware process and related process from the program memory of the protected computer.

11. The system of claim 10 wherein the related process is configured to restart the pestware process in the event the pestware process is terminated while the related process is running.

12. The system of claim 10, wherein the pestware removal module is configured to suspend either the pestware process or the related process before the other.

13. The system of claim 10 wherein the pestware removal module is configured to terminate the first suspended process while the second suspended process is suspended.

14. The system of claim 10, wherein the pestware removal module is configured to suspend the pestware process and the related process by placing the pestware process and the related process in debug mode so as to generate two process debug threads, each of the two process debug threads corresponding to one of the first suspended process and the second suspended process, and wherein the terminating includes terminating the two process debug threads.

15. The system of claim 10, wherein the pestware removal module is configured to suspend the pestware process and the related process by requesting an operating system of the protected computer to suspend the pestware process with a first suspend request and requesting the operating system to suspend the related process with another suspend request, and wherein the terminating includes requesting the operating system to terminate each of the first suspended process and the second suspended process with a corresponding one of two termination requests.

16. The system of claim 10 wherein the related process collects information about activities occurring on the protected computer.

17. The system of claim 10, wherein the pestware removal module is configured to suspend the pestware process and the at least one related process by preventing the pestware process and the at least one related process from being accessed by a processor of the protected computer.
